(19) United States
(12) Patent Application Publication
(10) Pub. No.: US 2015/0337729 A1
(43) Pub. Date: Nov. 26, 2015

(54) MULTI-STAGED THERMAL POWERED HYDRIDE GENERATOR

(71) Applicant: P. Mark Golben, Florida, NY (US)

(72) Inventor: P. Mark Golben, Florida, NY (US)

(73) Assignee: ERGENICS CORPORATION, Ringwood, NJ (US)

(21) Appl. No.: 14/716,819

(22) Filed: May 19, 2015

Related U.S. Application Data
(60) Provisional application No. 62/000,926, filed on May 20, 2014.

(51) Int. Cl. F02C 3/20; F02C 7/08

(52) U.S. Cl. CPC F02C 3/20; F02C 7/08

(57) ABSTRACT

An electric generator is driven by a gas turbine by using the impelling power of subatmospheric pressure hydrogen/deuterium released from hydrogen storage alloy contained in a first container and heated by indirect heat exchange with a heating medium while reabsorbing the hydrogen discharged from the gas turbine in a second hydrogen storage alloy contained in a second container and cooled by indirect heat exchange with a cooling medium. Alternately switching heating and cooling media contact with the hydride alloys maintains hydrogen gas flow as it is the pressure differential between the inlet pressure and the outlet pressure that is performing the work. Great volumes of hydrogen throughput, at subatmospheric pressures, operate the turbine. Electric energy is continuously and efficiently obtained from the electric generator. The principles can also be applied to other metal hydrides devices, e.g., pumps, compressors etc.

### CROSS REFERENCE TO RELATED APPLICATIONS

This is a non-provisional of provisional application Ser. No. 62/000,926, filed on May 20, 2014, the entire specification of which is incorporated by reference.

### BACKGROUND OF THE INVENTION

1. Field of the Invention

This invention relates generally to devices using low grade low grade heat from solar thermal, geothermal, ocean thermal, waste heat (“latent” or “waste” heat”) sources to manipulate hydrogen and metal hydrides and thereby to provide for electricity generation and also to a method of generating electric energy through operation of latent or waste heat on a hydrogen storage alloy system.

2. Background Art

Thermal hydrogen compressors for a broad range of applications have been known for over twenty years. Thermal compression of hydrogen using reversible metal hydride alloys offers an economical alternative to traditional mechanical hydrogen compressors. Hydride compressors are compact, silent, do not require dynamic seals or excessive maintenance and can operate unattended for long periods. Hydride compressors compress hydrogen and can also compress the hydrogen isotope Deuterium. The use of Deuterium is useful in the present invention due to the ability to enhance expansion efficiency because of the higher molecular weight of Deuterium relative to Hydrogen. In referring herein to hydrogen herein, the term “hydrogen” means isotopes, deuterium and hydrogen.

The hydrogen compressors are powered by latent or low grade heat, that is, heat that is excess heat derived from other processes as latent or waste heat that is a usually unwanted by-product that would otherwise be vented to the ambient environment. Such latent or waste heat can also be derived from other types of low grade thermal energy, such as ocean heat, geothermal or solar energy. Because the total energy consumption utilized for thermal hydrogen compression is only a fraction of that required for mechanical compression, using hydrogen will reduce the cost of hydrogen production and increase energy use efficiency. The simplicity and passive operation of the thermal compression process offer many advantages over mechanical compressors. Hydrogen compressors of this type are described in U.S. Pat. No. 4,282,931 and commonly owned U.S. Pat. Nos. 4,402,187; 4,505,120; 5,450,721; 4,781,246; 4,884,953; 5,623,987; 6,508,866, and U.S. Pat. No. 8,114,363, all the disclosures of which are incorporated by reference herein, as appropriate.

Additionally, other patents and applications utilize the principles and features of a hydride bed heat exchanger to provide either heating or cooling for buildings, automobiles and other enclosed spaces. For example, U.S. Pat. No. 6,520,249 describes a low temperature waste heat gas driven refrigeration system using hydrides to pump hydrogen between hydride beds and thus to provide a cooling capacity for refrigeration. U.S. Pat. No. 4,436,539 provides air conditioning by using a hydrogen heat pump; U.S. Pat. No. 4,439,111 describes a solar pumping installation utilizing hydrides.

Common to all of the heretofore known hydride compressor technologies is the use of metal hydrides to absorb and release hydrogen at appropriate times in the hydriding-dehydriding cycle so as to compress the hydrogen to ever higher pressures in a stairstep way by undergoing continual and repeated absorption/desorption steps. Hydrogen pressure in a metal hydride is known to increase exponentially with increasing temperature. The pressure rise generated in a single stage hydride heat exchanger heated with low-grade heat may be as high as 300%. Although theoretical pressure increases have been calculated to be as much as 500%, the effect of natural inefficiencies, such as heat transfer resistance and hydrogen pressure drop, tends to reduce the available pressure increase in actual practice.

Additional uses of hydride storage alloy systems as described above include methods and apparatus for generation of electrical energy. For example, U.S. Pat. No. 4,739,180, entitled “Method and apparatus for generating electric energy using hydrogen storage alloy” was issued to Yonoma et al. on Apr. 19, 1988. While these types of uses have been developed and expanded upon, they transfer hydrogen gas within a closed system at higher pressures. Because of the small relative size of the hydrogen atoms, and of hydrogen molecules, the hydrogen gas is more prone to find even miniscule leak paths which can lead to the possibility of leaking hydrogen to the atmosphere, both losing the hydrogen gas as a resource and possibly leading to unintended events.

Hydrogen gas streams utilized in other than metal hydride battery systems require modifications to these systems toward providing greater energy use efficiencies. For example, in aforementioned U.S. Pat. Nos. 5,450,721 and 5,623,987, drawn to an air conditioning system and a modular manifold hydrogen gas delivery system, respectively, a hydride compression arrangement utilizing several steps in a hydrogen compression process is described.

Heretofore, generation of electric power by means of a gas turbine using a source of heat having middle to low temperatures levels has been effected by evaporating a pressurized, condensable heat transfer medium such as water, Freon® gas or natural gases. The process includes introducing the resulting vapor into the gas turbine and impelling the gas against vanes connected to a shaft for driving same, condensing the vapor discharged from the gas turbine, and reheating the condensed liquid heat transfer medium for vaporization and for recirculation into the gas turbine. Conventional methods require the use of a heat transfer medium whose boiling point is considerably lower than the temperature of the heat source being used because the boiling point of the gas is constant under constant pressure. In order to condense the vapor of the heat transfer medium discharged from the gas turbine at high efficiencies, the temperature at which the heat transfer medium is condensed must be considerably higher than the temperature of a cooling source. For the above reasons, it is necessary that the difference in temperature between the heating and cooling sources in most gas turbine/generator combinations is large. The difficulty in driving a gas turbine in the above-described manner results in efficiency costs when using a heat source of middle-low levels (50°-150° C.) and a cooling source of about 10°-30° C.

Systems utilizing recapture “low grade” heat require a source of heat that is otherwise radiated or vented to the environment, or removed by a heat sink or other similar device, or is available as latent or ambient heat, for example, solar or geothermal. Other sources of low grade or ambient heat may also come to mind, so long as it can be utilized to provide the driving force in a thermal hydriding-dehydriding system.

None of the heretofore known devices have considered the use of gas at low pressure or subatmospheric pressure for providing the motive force for powering a generator. Low and ultralow pressures have not been considered for the most part because low pressures are not considered to have high motive power for driving turbines. This has been the general past experience when designing engines using the Carnot cycle and other known fuel combustion engines.

Although devices have been described in which solar energy is used to generate and store hydrogen in a storage vessel, for example in U.S. Pat. Nos. 5,512,145 and 6,610,193, for later use in an energy producing device, for example, in a fuel cell, none of the devices heretofore known are capable of directly producing electrical power through a generator motor or turbine driven by low, subatmospheric pressure hydrogen gas moving therethrough.

### SUMMARY OF THE INVENTION

Continuous pressure differentials in hydrogen pressure provide the motive power for the generator shaft, and the amount of power available from the lower pressures is compensated by an increase in the volume of the hydrogen flow. The pressure differential is produced by providing two identical hydride heat exchanges alloy storage “beds”, and utilizing simple and reliable one-way hydrogen check valves between the beds, in an arrangement such as is disclosed in commonly owned U.S. Pat. No. 6,042,960, described in greater detail below. When one of the hydride beds is heated and the other bed is cooled, hydrogen absorption and compression occurs simultaneously in different parts of the closed system. Following completion of the hydrogen transfer between two separated beds, the heat source is exchanged at the source or the flow is reversed, for example, the hot and cold water flow is reversed, and hydrogen absorption and compression, again, occurs simultaneously, except hydrogen flow occurs in the opposite direction before the reversal.

Alternatively, and in accordance with the teaching of U.S. Pat. No. 4,739,180, a simple switching of the check valves permitting the gas to flow in opposite directions provides for the gas flow reversing function. The use of one-way hydrogen check valves, such as one of the two valves illustrated and described in commonly owned U.S. Pat. No. 6,042,960, prevents the hydrogen from back flowing to the hydride bed from which the hydrogen was desorbed in the previous portion of a cycle. The procedure in a simple and passive process allows the hydrogen to flow through the turbine at a low or ultra low pressure whenever a small pressure differential capable of opening the one way check valve (about 1 psi) is present.

In another aspect of the invention, an inventive configuration of check valves, such as those described in commonly assigned U.S. Pat. No. 6,042,960, permits the essentially automatic operation of the device so that the flow of hydrogen, controlled by the relative pressures in the various pipes of the system, is always in a single direction providing the necessary flow across the gas expansion turbine to drive impellers and a shaft thereby to generate electricity. The automatic operation can be effectuated by pressure sensors in the pipes of the system to recognize the optimal timing for when to switch the flow of heating and cooling media to build-up pressure through desorption and to reduce pressure through absorption by the respective hydride alloys in the hydride beds in the at least two containers therefor.

In accordance with one aspect of the present invention, there is provided a method of generating electric energy, comprising the steps of providing a gas expansion turbine, an electric generator operatively connected to said gas turbine and capable of generating electric energy when the gas turbine is driven, and a plurality of zones each containing a hydrogen storage alloy capable of absorbing hydrogen upon being cooled and of releasing the absorbed hydrogen upon being heated, heating the hydrogen storage alloy in at least one of the plurality of zones while cooling the hydrogen storage alloy in at least one of the other zones, so that the heated hydrogen storage alloy releases hydrogen into the system, impelling the released hydrogen into the gas turbine to drive the shaft, and feeding the hydrogen used for driving the gas turbine to at least one of the other zones containing a hydrogen storage alloy being cooled to allow the released hydrogen to be reabsorbed thereby.

Low or ultralow, including subatmospheric, pressures of hydrogen in conjunction with metal hydrides used as a motive power can be expanded beyond generators. For example, metal hydride pumps, compressors, purification devices and other hydrogen-hydride devices are known, and described in numerous articles and patents, including commonly assigned U.S. Pat. Nos. 4,505,120, 4,884,953, 7,736,609 and 8,114,363. The benefits and advantages deriving from the present invention will be evident to a person having skill in the art so that these types of devices will be readily modified for operation in ultralow or subatmospheric pressures, as described herein for generators.

### BRIEF DESCRIPTION OF THE DRAWINGS

The present invention will now be discussed in further detail below with reference to the accompanying figures in which:

FIG. 1 is a schematic drawing showing the concepts present in a generator turbine combination according to the present invention.

FIG. 2 is a fluid flow schematic diagram of a simplified hydride heat pump according to the present invention showing the hydride heat exchanger beds, valving, turbine generator, piping and fluid flow pathways that are generally needed to generate electricity using a metal hydride system;

FIG. 3 is very similar to the fluid flow schematic diagrams for FIG. 2 but with the addition of dual check valve arrangement having fluid valves, and is useful in illustrating how electricity generating operation, can be employed in the same device.

FIG. 4 illustrates in graphical form the efficiency and effect of utilizing deuterium in respect to the pressures generated and the maximum permissible RPMs as a result of limitations therein resulting from the use of foil bearings.

### DETAILED DESCRIPTION OF THE PREFERRED EMBODIMENTS

The description below should be understood in the context of general principles of metal hydride alloy technology. It is well known that metal hydrides have a capability to absorb (charge) and desorb (discharge) hydrogen gas as a function of temperature. It should be recognized that the generation of electricity using these types of systems and using specific are described elsewhere, including in the above mentioned patents and applications to which reference is made, which provide for a more detailed description of metal hydride alloys and metal hydride technology, fluid flow and valve positioning for most efficient operation.

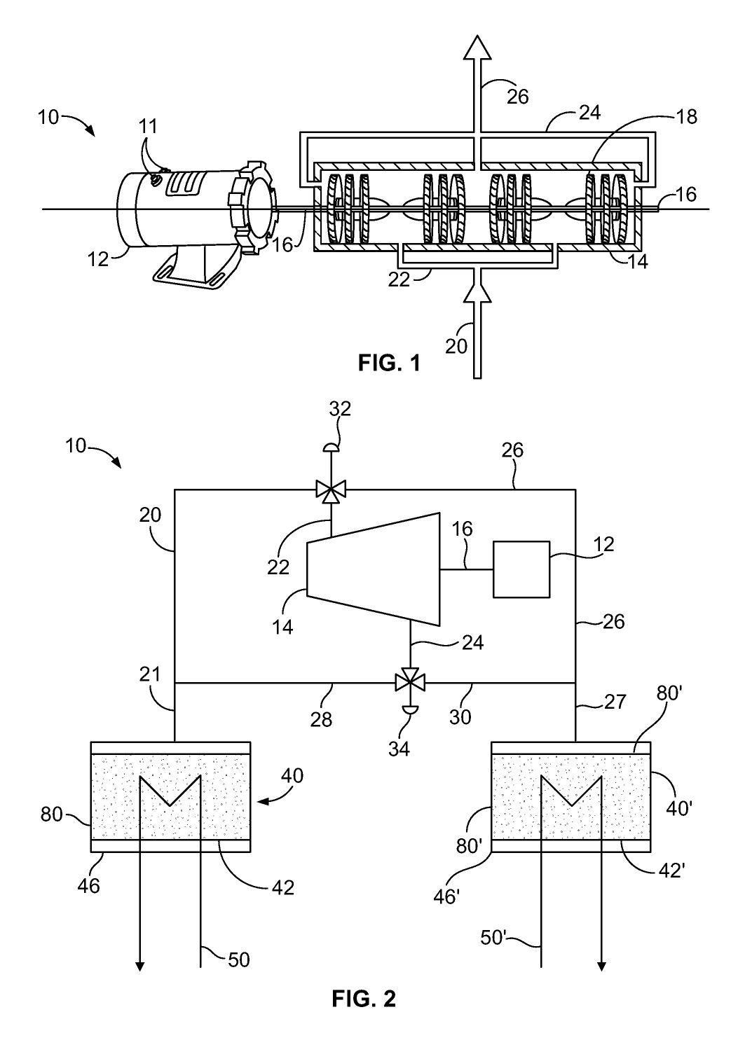

FIGS. 1 through 3 generally relate to each other in describing the operation of a generating plant utilizing known metal hydride systems. Referring now to FIG. 1, the reference numeral 10 denotes a generating system according to the present invention, including a generator 12, a gas turbine 14, and a shaft 16 mechanically connecting gas turbine to generator 12. As the turbine 14 rotates the shaft 16, it generates electricity in the generator 12 which is drawn off for use in an electrical grid through electrical connectors 11 on the generator 12. The general operation of the generator 12 is known and not a significant part of this invention.

Turbine 14 is a gas turbine of known construction, but has a plurality of vanes 18 that are attached to shaft 16 in a concentric relationship. As gas at a higher pressure flows into the gas turbine 14 through the inlet pipe 20 and manifold 22, the gas is directed to impel the vanes 18 and so rotate the shaft 16 in a desired direction. Manifolds for delivery of hydrogen gas are known and described, for example in commonly assigned U.S. Pat. No. 5,623,987. These manifolds enable the distribution of hydrogen gas to numerous ports at essentially the same pressure before entry into the gas turbine 14.

After the gas completes the impelling function in the gas turbine 14, it is collected at a lower pressure relative to the inlet pressure at the outlet manifold 24. Then it is directed to the outlet pipe 26 for directing back to the hydride beds 80, 80′ (FIG. 2), thereby to provide a higher pressure gas in a continual cycle as is explained in greater detail below.

Referring now to FIG. 2, a first heat exchange zone, generally a heat exchanger 40, accommodating a bed 80 of a hydrogen storage alloy which has absorbed hydrogen, provides a heat source that selectively heats and cools the metal hydride bed 80. A second heat exchange zone 40′, similar to the first heat exchange zone 40, accommodates a bed 80′ of a hydrogen storage alloy which is generally the same as the alloy in the first heat exchange zone 40 and which has released hydrogen in a cycle. The first and second heat exchangers 40, 40′ generally comprise first and second sealed, closed containers 46 and 46′, respectively, in which first and second heat transfer members, such as heat transfer pipes 42, 42′, respectively, are disposed for heating or cooling the hydrogen storage alloy beds 80, 80′ contained in the first and second containers 46 and 46′. The heat exchange process is performed by indirect heat exchange with heat transfer media flowing through the heat transfer pipes 42, 42′. The heat transfer media are introduced in the first and second heat transfer pipes 42, 42′ through feed conduits 50, 50′, respectively.

The gas turbine 14 is connected through a transmission shaft 16 to an electric generator 12 so that, as the shaft 16 of generator 12 is rotated by the turbine 14, it generates electric energy or power. The gas turbine 14 has a hydrogen inlet conduit 20 which is connected, via three-way valve 32, to both the heat exchangers 40, 40′ through pipes 20, 22, 24 and 26. The gas turbine 14 also includes a hydrogen outlet conduit 24 connection, via three-way valve 34, both to the first heat exchanger 40 through pipes 28 and 21 and to the second heat exchanger 40′ through pipes 30 and 27.

The apparatus constructed operates as follows. While maintaining the three-way valves 32 and 34 in their closed positions, the hydrogen storage alloy in bed 80 in the first heat exchanger 40 is heated by introducing a heating medium such as a flow of water or other heat transfer means which has been heated by a solar collector or from low grade heat. The heat medium flows through the line 50 into the first heat transfer pipe 42. The hydrogen gas previously absorbed in the hydride alloy of bed 80 is thus released from the bed 80 and the first container 46 and the pipes 21, 20 and 28 are filled with hydrogen at a temperature of T₁ and a pressure of P₁. At the same time, the hydrogen storage alloy in bed 80′ is cooled indirectly by introducing a cooling medium for example, water taken from a cool reservoir, into the second heat transfer pipe 42′ through the line 50′, so that the hydride bed 80′ inside the second container 46′ has a temperature T₂ and a pressure P₂.

The three-way valves 32 and 34 are then actuated to selectively communicate the inlet conduit 22 with the pipe 28 and to selectively communicate the outlet conduit 24 with the pipe 26. As a result, the higher pressure hydrogen is introduced into the gas turbine 14 through lines 21, 20 and 22 and, thereby impelling the vanes 18 (FIG. 1) and rotationally driving the shaft 16 of gas turbine 14 and the electric generator 12. Then the hydrogen gas at a lower pressure passes through outlet lines 24, 30 and 27 to the second container 46′ of the second heat exchanger 40′ where the hydrogen is reabsorbed by the alloy bed 80′. In this case, there are maintained relationships of P₁ >P₂ and T₁ >T₂ while the alloy in bed 80 in the first heat exchanger 40 releases the absorbed hydrogen and the alloy in bed 80′ absorbs the released hydrogen returning at the lower pressure. Therefore, the gas turbine 14 continues to operate and the shaft 16 rotates the within the generator 12 to produce electricity until the gas in system arrives at an equilibrium pressure.

When desorption of hydrogen gas from the alloy in bed 80 in the first heat exchanger 40 diminishes as pressure equilibrium is reached, the valves 32 and 34 are again closed. Then, the heating medium is supplied to the second heat transfer pipe 42′ while the cooling medium is introduced into the first heat transfer pipe 42 so that the hydrogen gas, absorbed in the previous step in the alloy bed 80′ in the second heat exchanger 40′, is desorbed therefrom and fills the lines sequentially 27, 26 and 22 and the gas in container 46′ reaches as new equilibrium at a temperature of T₂′ and a pressure of P₂′. The valves 32 and 34 are then opened to permit flow of hydrogen through the pipe 26 and into line 22 and the line 24 into the line 28. This results in the introduction of the hydrogen at T₂′ and P₂′ into the gas turbine 14, thereby continuing the impelling and driving of electric generator 12 operatively connected to the gas turbine 14 through shaft 16. The hydrogen gas then flows through lines 24, 28 and 21, to the first heat exchanger 40 where it is absorbed by the alloy in bed 80 in the first heat exchanger 40 at a temperature of T₁′ and a pressure of P₁′. Since P₁′<P₂′ and T₁′<T₂′, the gas turbine 14 is driven with the higher pressure hydrogen serving as the working gas.

The operational steps as described above are repeated to continuously drive the shaft 16 and thereby to obtain electric energy from the generator 12. In this case, since the efficiency in the turbine 14 depends upon the difference in temperature in the incoming hydrogen and the exhaust hydrogen, it may be more effective to provide a heater (not shown) in the hydrogen inlet conduit 22 to improve the operation efficiency of the gas turbine 14.

“Volumetric efficiency” in an expansion device, such as turbine 14, for use with a generator 12 using ultra low pressures requires the system to utilize a high volume of hydrogen throughput. Ideally, use of low pressure can be subatmospheric and a negative pressure environment, relative to ambient, may be used to generate electrical power from latent or solar heat.

The better the volumetric efficiency, the more work is obtained from a similar volume of gas. Since hydrogen gas has a low MW (2.016), it is liable to leak past seals, blades, vanes more (or easier than) than higher MW gases like steam (MW=18) or Dichlorodifluoromethane (Freon®, MW=102), thereby reducing the volumetric efficiency. It has been found that a marked increase in the volumetric efficiency of hydrogen in an expansion device can be achieved by operating at very low or subatmospheric pressures. Hydrogen volume at very low pressure is so high, that the percentage of hydrogen that leaks past internal seals or leaks out of the closed system 10 without doing any work is reduced, thereby substantially increasing volumetric efficiency and increasing overall expansion efficiency.

It has also been disclosed that deuterium can replace hydrogen as a diffused gas in metal hydrides. While the increase in volumetric efficiency provides a benefit when using molecular hydrogen, added or enhanced efficiencies may result from the use of deuterium instead of hydrogen while maintaining the functionality of the metal hydride to absorb deuterium. The added molecular weight of deuterium molecules, effectively twice that of hydrogen molecules, provides additional gravitational forces that more effectively impel the vanes of an expansion turbine, such as gas turbine 14. Thus, use of deuterium is considered to add significantly to the volumetric efficiency of the turbine and thus of the generator in general.

Collateral benefits of utilizing these type of devices include low pressure construction (less material and less rugged elements are needed to withstand the pressure), lower rotational speed for practical electrical generation, lower rotational speed reduces stress on rotating materials, allowing lighter weight/less expensive construction. Low pressure operation does not reduce the work obtained form the system, since it can be done at the same expansion ratio as higher pressure machines as it is the inlet-to-outlet pressure ratio that performs the work, not the absolute pressure of any one chamber or pipe. Just like the known steam turbine, as described in U.S. Pat. No. 1,089,710, hydrogen volume at ½ atmosphere (7.3 psi) is twice that at atmospheric pressure, at ¼ atmosphere (3.65psi) is 4 times that at 1 atm., at ⅛ atmosphere (1.82 psi) is 8 times more than at 1 atm. and at 1 psia is 14.7 times more than at 1 atm. Thus, multiple expanders, each having several vanes 18 in the same turbine 14, are provided to accommodate the high gas volume of the hydrogen throughput that must go from higher, albeit still subatmospheric, pressure to lower pressure. Higher volume provides for better performance with a low MW fluid, such as hydrogen, which is ideal for this purpose. Prior efforts, for example using steam, sacrifice efficiency when using the volume to extract the last few BTU's from steam before condensation.

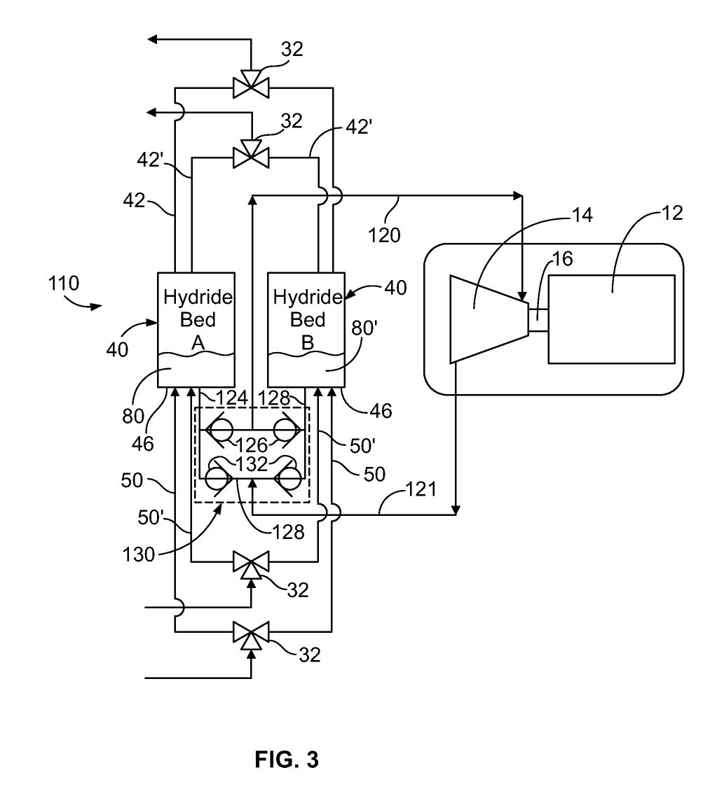

Referring now to FIG. 3, a second embodiment of the device 110 is shown using an expansion turbine 14. In this embodiment, like parts will be identified by like numerals, only different elements having a like function will be identified by a different number having a different initial digit. The embodiment of a gas generator turbine 110 shown in FIG. 3 has a first heat exchange zone, generally a heat exchanger 40, accommodating a bed of a hydrogen storage alloy 80 which has absorbed hydrogen (or deuterium). The heat exchanger 40 provides a heat source that selectively heats and cools the metal hydride alloy 80.

A second heat exchange zone 40′, similar to the first heat exchange zone 40, accommodates a bed of a hydrogen storage alloy 80′, which is generally the same as the alloy 80 in the first heat exchange zone 40 and which has released hydrogen therefrom. The first and second heat exchanger zones 40, 40′ generally comprise first and second sealed, closed containers 46 and 46′, respectively, in which first and second heat transfer members, such as heat transfer pipes 42, 42′, respectively, are disposed for selectively heating or cooling the hydrogen storage alloys 80, 80′ contained in the first and second containers 46 and 46′. This is generally done by indirect heat exchange with heat transfer media flowing through the outlet pipes 42, 42′, and inlet feed conduits 50, 50′, which in turn are connected to sources of low grade heat, as described above, and a cooling source, respectively, not shown in FIG. 3.

The heat transfer media are introduced in the first and second heat transfer pipes 42, 42′ through feed conduits 50, 50′, respectively. The flow of the heating and cooling media through the pipes 42, 42′ and through-feed conduits 50 are controlled by several three way cut-off valves 32 that provide for the desired fluid flow direction of the cooling and heating fluids, essentially as in the embodiment of FIG. 2.

A gas turbine 14, to which an electric generator 12 is connected through a transmission shaft 16, operates to generate electric energy or power upon rotation of the shaft 16 by the gas turbine 14. The gas turbine 14 has a hydrogen inlet conduit 120 which is connected, via inlet/outlet pipes 122, 124 and going through specified grouping of one valves 132, referred to herein as the dual check valve arrangement 130. The operation of the one-way valves 132 follows the teaching of commonly assigned U.S. Pat. No. 6,042,960, with respect to the dual check valve arrangement 130 to produce a continuous flow of higher, albeit subatmospheric, pressure hydrogen in one flow direction. The disclosure of U.S. Pat. No. 6,042,960 is incorporated by reference, as if fully set forth herein. The resulting flow-through of the lower pressure hydrogen from the expansion turbine 14 reaches the point between the two check valves 132 and the valve 132 that will open is the one that has lower pressure on the other side than is in the return conduit 121, as will be explained below with respect to the device operation.

Both heat exchangers 40, 40′ provide fluid communication to the containers 46, 46′ only through the pipes 122 and 124. The gas turbine 12 also has a hydrogen outlet conduit 121 which is connected, via dual check valve arrangement 130, to both the first heat exchanger 40 through pipe 122, and to the second heat exchanger 40′ through pipe 124.

The apparatus 110, thus constructed, operates as follows. While maintaining the dual check valve arrangement 130 in a static position, the hydrogen storage alloy 80 in the first heat exchanger 40 is heated by introducing a heating medium such as a flow of warm water or other heat transfer means which has been heated by a solar collector or from a low grade heat source, flowing through the line 50. As result of the heating of the hydride bed 80, the hydrogen absorbed in the hydride alloy 80 is thus released therefrom and the first container 46 and the pipe 122 are filled with hydrogen at an increased temperature of T₁ and pressure of P₁. As temperature T₁ and pressure P₁ increase, the pressure will continue to rise until it is greater than the pressure P₂ in the pipe 126 (P₁>P₂). As this occurs, at some point the one-way valve 132 between pipes 122 and 126 will open to permit the hydrogen to flow from pipe 122 and into pipe 126 and thereby into conduit 120, thus powering the expansion turbine 14 by the hydrogen flow and impelling the turbine vanes through expansion from the higher pressure to the lower pressure.

At the same time, the hydrogen storage alloy 80′ is cooled indirectly by introducing a cooling medium, for example, water taken from a cooling reservoir, into the second heat transfer pipe 50′ and removing it through the conduit 42 so that the inside of the second container 46′ has a temperature T₃ and a pressure P₃. As the pressure is reduced to that below the pressure P₂, that is, P₂ >P_{3,} the valve 132 between pipes 124 and 126 closes of the hydrogen flow from pipe 126 into pipe 124. As result of the configuration of dual check valve arrangement 130, valves 132 permit the flow of hydrogen into the conduit 120 at the appropriate times for the operation to continually flow in a single direction at a relatively constant rate, and thereby to continue the generation of electrical power at low pressures but at high efficiency.

Simultaneously to this process, the second portion of the dual check valve arrangement 130, having two additional one way valves 132, oppositely oriented in respect to fluid flow to those above described, also operate to provide hydrogen gas flow in the opposite direction, that is, from expansion turbine 14 to the hydride bed 80′ in container 46′. The dual check valve arrangement 130 is automatically actuated to selectively communicate the inlet conduit 121 with the pipe 124 to provide for absorption of the hydrogen gas by the hydride bed 80′. That is, as the pressure P₄ in the pipes 121, 128 exceeds the pressure P₃ in pipe 124 the one-way valve 132 between these pipes opens and communications is open for hydrogen flow to commence from expansion turbine 14 to hydride bed 80′. Simultaneously, because the pressure P₁ is greater than the pressure P₄, valve 132 between pipes 122 and 128 shuts off the hydrogen flow therebetween. When the pressures begin to approach equilibrium, the three way valves are simply switched, and in the arrangement shown, switched automatically, so that the pipes that were carrying cooling medium begin to provide heated medium to the hydride beds 80, 80′, and vice versa.

As a result, the higher pressure hydrogen is introduced into the gas turbine 14 through pipe 120 and, after impelling the vanes 18 (FIG. 1) and driving the shaft 16 of gas turbine 14 and the electric generator 12, the hydrogen gas at a lower pressure passes through pipe 121 to the appropriate container 46, 46′ of the appropriate heat exchanger 40, 40′ where the hydrogen is reabsorbed by the respective alloy 80, 80′. Therefore, the gas turbine 14 continues to operate without slowing down and shaft 16 rotates the within the generator 12 to produce electricity until the system arrives at an equilibrium and the flows of the two cooling and heating media are reversed.

One distinct advantage of the device 110 shown in FIG. 3 is the operation of the valves 132 is essentially automatic, and need not be controlled by the system in any way. That is, the relative pressures of the hydrogen gas in the pipes controls the hydrogen flow, and he pressures are regulated by the cooling and heating media that provide the heat of desorption and cool to provide absorption of the hydrogen gas by the respective hydride beds 80, 80′. Thus, as pressure sensors in the respective pipes can be utilized to provide an algorithm for the optimal moments in which to switch the direction of flow of the heating and cooling media, the low subatmospheric pressure, albeit at higher than standard volumes, can be used to provide a continuous impelling force on the vanes and a continuous driving of the shaft 16 to generate electrical power from generator 12.

The operation as described above are repeated to continuously obtain electric energy from the generator 12. In this case, since the efficiency in the turbine 14 depends upon the difference in temperature in the incoming hydrogen and the exhaust hydrogen, it may be more effective to provide a heater (not shown) in the hydrogen inlet conduit 122 in improving the operation efficiency of the gas turbine 14, but this is not a requirement. It should be understood that use of an arrangement with a heater (not shown) will result in a decrease in efficiency because of the power necessary to heat the fluids.

Foil bearings have been known for use in high or ultrahigh rotational speeds and operations, e.g. U.S. Pat. No. 4,445,792. Operating turbines at sub-atmospheric pressures is desirable because of limitations placed on foil bearings. Foil air bearings, unlike contact-roller bearings, utilize a thin film of pressurized air between relatively moving or rotating surfaces to provide an exceedingly low friction load-bearing interface. The two relatively moving or rotating surfaces are non-contacting because of the air gap formed therebetween during operation. Being non-contacting, foil bearings avoid the traditional bearing-related problems of friction, wear, particulates, and lubricant handling, and offer distinct advantages in precision positioning, such as lacking backlash and stiction (static friction), as well as in high-speed applications. Foil bearings excel where high temperature and high rotational speed bearings are needed. Working in sub-atmospheric pressures permits for superior performance.

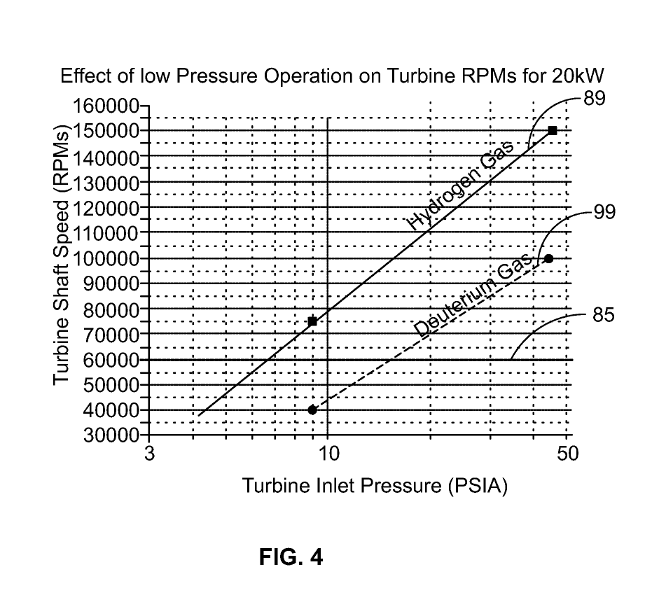

A direct correlation exists between the effects of low pressures and turbine revolution speeds as measured by revolutions per minute (RPMs). The maximum permissible RPMs for foil bearings is around 60,000 RPMs (line 85 in FIG. 4), which speeds are only achievable if the turbines operate at gas inlet pressures below 15 pounds per square inch (psia), which represents atmospheric pressures at seal level. Thus, the use of sub-atmospheric pressures is necessary for the shaft speeds to be less than 60,000 RPMs in using most gasses. FIG. 4 shows in graph form how a four stage, 3/1 expansion ratio, 20 kW turbine/generator designed for either Hydrogen gas (black line 89) or Deuterium gas (broken line 99). The graph illustrates that for those embodiments using deuterium gas as the working gas, the shaft speed will only be reduced to 60 k RPMs if operation of the turbine at gas inlet pressures is below 15 psia. Thus sub-atmospheric gas pressures will be a crucial requirement for use of these types of electric generators.

Other types of low grade heat sources may be used to recapture the low grade heat that would otherwise be dissipated into the environment. These sources may be used to transfer the heat energy into other types of energy, for example, electrical power, that may be immediately used as needed, or alternatively, may be stored for later use, for example, in hydrogen storage vessels commercially available from Ergenics Corporation of Ringwood, N.J., USA.

Other modifications will be readily apparent to one having ordinary skill in the art. For example, the hydride bed arrangement described above may require make up sources of hydrogen gas if a hermetic sealed system is not provided. Thus, the invention illustrated and described in the above embodiments is thus understood to be for exemplary purposes only, and is not to be limited by the examples of the embodiments shown and described therein, but the invention is to be limited only by the elements and limitations recited in the following claims and their equivalents.

What is claimed is:

1. A gas turbine capable of being operated at subatmosheric pressure for generating electric energy, comprising:
a gas turbine capable of operating at subatmospheric pressure;
an electric generator operatively connected to said gas turbine and capable of generating an electric energy when said gas turbine is driven;
at least one heat exchange zone each containing a hydrogen storage alloy capable of absorbing hydrogen upon being cooled and of releasing the absorbed hydrogen upon being heated and each heat exchange zone being adapted for sequentially heating and cooling the hydrogen storage alloy contained therein by indirect heat exchange with a heating or a cooling medium supplied thereto in corresponding sequential steps;
heating medium supply conduit means connected to said plurality of heat exchange zones for supplying the heating medium to respective heat exchange zones;
cooling medium supply conduit means connected to said plurality of heat exchange zones for supplying the cooling medium to respective heat exchange zones;
first valve means provided in said heating medium and cooling medium supply conduit means and operable so that each of said heat exchange zones is supplied with the heating and cooling media alternately and that at least one of said plurality of heat exchange zones is supplied with the heating medium with at least one of the other zones being supplied with the cooling medium, whereby hydrogen is released from the hydrogen storage alloy heated by indirect heat exchange with the heating medium;
hydrogen feed pipes extending between said plurality of heat exchange zones and said gas turbine for introducing the released hydrogen from respective heat exchange zones into said gas turbine;
hydrogen discharge pipes extending between said plurality of heat exchange zones and said gas turbine for feeding the hydrogen from said gas turbine to respective heat exchange zones;
second valve means provided in said hydrogen feed pipes and operable so that the passage of hydrogen through the hydrogen feed pipes is prevented except those leading from said at least one of said plurality of heat exchangers; and
third valve means provided in said hydrogen discharge pipes and operable so that the passage of hydrogen through the hydrogen discharge pipes is prevented except those leading to said at least one of the other heat exchange zones, whereby the hydrogen released from said at least one of said plurality of heat exchange zones is introduced into said gas turbine to drive same and is then reabsorbed by the hydrogen storage alloy in said at least one of the other heat exchange zones cooled by indirect heat exchange with the cooling medium.

2. A method of generating an electric energy, comprising the steps of:
a) providing a gas turbine, an electric generator operatively connected to said gas turbine and capable of generating an electric energy when said gas turbine is driven, and a plurality of zones each containing a hydrogen storage alloy capable of absorbing hydrogen upon being cooled and of releasing the absorbed hydrogen upon being heated;
b) heating the hydrogen storage alloy in at least one of said plurality of zones while cooling the hydrogen storage alloy in at least one of the other zones, so that the heated hydrogen storage alloy releases hydrogen;
c) introducing said released hydrogen into said gas turbine to drive same; and
d) feeding the hydrogen used for driving said gas turbine to said at least one of the other zones containing the hydrogen storage alloy being cooled to allow the released hydrogen to be reabsorbed thereby.

3. A gas turbine for operation at subatmosheric pressures comprising:
a) a plurality of expansion zones shaped, dimensioned and oriented to accommodate high actual gas flow rates associated with ultra low subatmospheric pressure operation;
b) at least one reservoir containing gas maintained at ultra low subatmospheric pressure;
c) segmented pipes in fluid communications with said at least one reservoir containing gas at ultra low subatmospheric pressure for providing a flowpath of said gas from said reservoir to said plurality of expansion zones; and
d) segmented pipes in fluid communications with at least one reservoir containing subatmospheric gas for providing a flowpath of said subatmospheric gas from said plurality of expansion zones to said reservoir.

4. An apparatus for generating electric energy comprising:
a) a gas turbine capable of operating at subatmospheric pressure;
b) a gas reservoir for driving the gas turbine;
c) associated transfer piping for transferring gas from the gas reservoir to the gas turbine and returning the gas from the gas turbine to the gas reservoir;
d) shut-off valves for controlling the flow of the gas within the transfer piping;
e) an electric generator operatively connected to said gas turbine and capable of generating electric energy when said gas turbine is driven by the flow of gas therewithin; and
f) a container having sealed electrical feed-throughs surrounding said gas turbine and said electric generator, said container comprising hermetically sealed walls to retain therewithin and prevent leakage to the atmosphere of gas and to prevent air at atmospheric pressure from entering said container, wherein the internal pressure within said gas reservoir is at subatmospheric pressure and wherein the gas consists of a gas selected from a group comprising hydrogen and deuterium.

5. The apparatus for generating electric energy according to claim 5 wherein the shut-off valves further comprise one-way hydrogen check valves.

6. The apparatus for generating electric energy according to claim 5 wherein the shut-off valves further comprise three-way hydrogen check valves controlled by the relative pressures within the piping on either side of said three-way valve.

7. The apparatus for generating electric energy according to claim 5 wherein the gas flow within the transfer piping is governed by electronic controls controlling switches in selected ones of said the shut-off valves.

8. The apparatus for generating electric energy according to claim 5 wherein the gas flow within the transfer piping is governed by relative pressures within the piping on either side of said three-way valve by opening the check valve to permit gas on one side of said check valve to flow toward the opposite lower pressure side of said check.

9. The apparatus for generating electric energy according to claim 5 wherein the gas flow to and from said gas reservoir is forced by sequential application of external heating and cooling medium applied to the gas reservoir through said container walls.

10. The apparatus for generating electric energy according to claim 5 wherein seals are provided to the relatively rotating elements of the gas turbine to maintain a hermetic seal of the container within said gas turbine.

11. The apparatus for generating electric energy according to claim 10 wherein the seals further comprise foil bearing seals.
